(19) United States
(12) Patent Application Publication
(10) Pub. No.: US 2011/0225943 A1
(43) Pub. Date: Sep. 22, 2011

(54) Anti skid rake for parked rakes

(76) Inventor: Heiko Friedlein, Kulmbach (DE)

(21) Appl. No.: 12/932,825

(22) Filed: Mar. 8, 2011

(30) Foreign Application Priority Data
Mar. 21, 2010 (DE) 10 2010 012 491.5

(51) Int. Cl. A01D 7/00

(52) U.S. Cl. 56/400.04

(57) ABSTRACT

Attachments of material with a huge friction factor on the termination points of the armrests of medical rakes.

These anti friction points are firmly connected with the rake so when it is parked on a wall the friction factor of the whole medical tool is increased so it will repose even if its position is not orthogonal or almost orthogonal to the ground.

The Anti skid rake for parked rakes is to help people who use it to more convenience in their daily life. Problem: When a rake is parked e. g. at a wall, it easily slides to the side and on the ground when it is not parked straight enough.

The idea is, to put a slide-protection in the form of mainly two e. g. rubber elements on the very out sides of the armrest so the friction factor will increase and the rake will stay in it's parked position.

The rubber elements on the outer ends of the armrest could also e. g. gloom in the night and are in a firm connection with the armrest.

### DRAWING

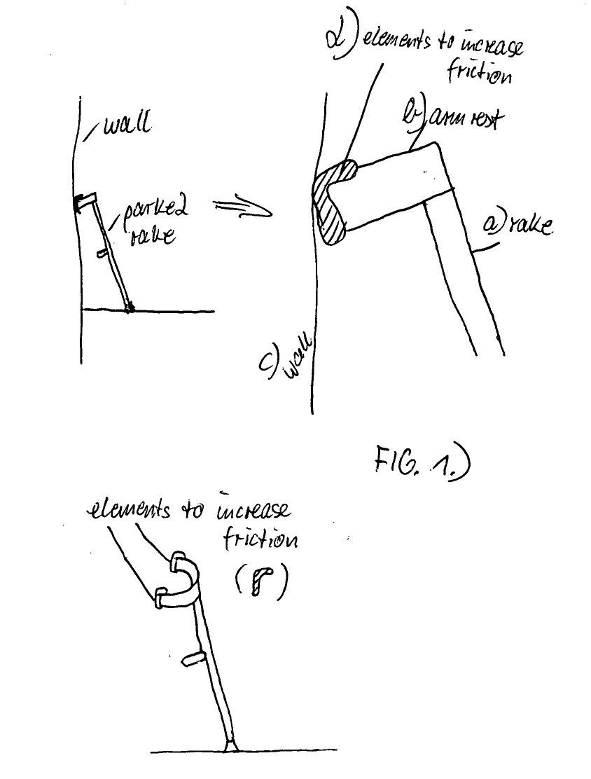

FIG. 1.)
a.) =rake
b.) =armrest
c.) =wall
d.) =elements to increase the friction factor

1. I claim as invention the addition of elements e. g. of rubber material on the ends of the armrests of rakes to increase the friction factor when they are parked e. g. on a wall so they don't skid to the ground as easy as they would without the attachments.
